(19) United States
(12) Patent Application Publication
(10) Pub. No.: US 2025/0249390 A1
(43) Pub. Date: Aug. 7, 2025

(54) CO2 CAPTURE DEVICE

(71) Applicant: TOYOTA JIDOSHA KABUSHIKI KAISHA, Toyota-shi (JP)

(72) Inventor: Takahiro SADAMITSU, Miyoshi-shi (JP)

(73) Assignee: TOYOTA JIDOSHA KABUSHIKI KAISHA, Toyota-shi (JP)

(21) Appl. No.: 18/965,271

(22) Filed: Dec. 2, 2024

(30) Foreign Application Priority Data
Feb. 6, 2024 (JP) 2024-016274

(51) Int. Cl. B01D 53/04

(52) U.S. Cl. CPC B01D 53/0438; B01D 2253/3425; B01D 2257/504; B01D 2259/4009; B01D 2259/402

(57) ABSTRACT

A CO₂ capture device according to the present disclosure includes: a channel through which gas is passed; a first CO₂ adsorption member and a heat absorption member that are disposed in the channel; a first insertion port through which a fluid is inserted into the channel in such a manner that the fluid flows through the heat absorption member via the first CO₂ adsorption member; and a second insertion port through which the fluid is inserted into the channel in such a manner that the fluid flows through the first CO₂ adsorption member via the heat absorption member. The fluid is passed through the heat absorption member via the heated first CO₂ adsorption member to heat the heat absorption member. When heating the first CO₂ adsorption member, the fluid is passed through the first CO₂ adsorption member via the heat absorption member to heat the first CO₂ adsorption member.

### CROSS-REFERENCE TO RELATED APPLICATION

This application claims priority to Japanese Patent Application No. 2024-016274 filed on Feb. 6, 2024, incorporated herein by reference in its entirety.

### BACKGROUND

### 1. Technical Field

The present disclosure relates to CO₂ capture devices.

### 2. Description of Related Art

CO₂ capture devices that capture CO₂ contained in gas using a CO₂ adsorption member (i.e., a solid adsorption member) have been put to practical use. Such a CO₂ capture device is configured to capture CO₂ by heating the CO₂ adsorption member to desorb CO₂ from the CO₂ adsorption member.

For example, a CO₂ capture device of Japanese Patent No. 5914300 (JP 5914300 B) is configured to capture CO₂ by heating a CO₂ adsorption member in a contactless manner using steam extracted from a steam turbine to desorb CO₂ from the CO₂ adsorption member.

### SUMMARY

The applicant found the following issue. The CO₂ capture device of JP 5914300 B is configured to heat the CO₂ adsorption member in a contactless manner. Therefore, heat is not easily transferred to the CO₂ adsorption member, resulting in low waste heat utilization efficiency.

The present disclosure was made in view of such an issue, and implements a CO₂ capture device that contributes to improving waste heat utilization efficiency.

A CO₂ capture device according to one aspect of the present disclosure is a CO₂ capture device that captures CO₂ from gas. The CO₂ capture device includes: a channel through which the gas is passed to capture CO₂; a first CO₂ adsorption member disposed in the channel; a heat absorption member disposed next to the first CO₂ adsorption member in the channel; a first insertion port that is provided in the channel and through which a fluid is inserted into the channel in such a manner that the fluid flows through the heat absorption member via the first CO₂ adsorption member; and a second insertion port that is provided in the channel and through which the fluid is inserted into the channel in such a manner that the fluid flows through the first CO₂ adsorption member via the heat absorption member. The fluid is passed through the heat absorption member via the first CO₂ adsorption member heated to desorb CO₂ to heat the heat absorption member. When heating the first CO₂ adsorption member, the fluid is passed through the first CO₂ adsorption member via the heat absorption member to heat the first CO₂ adsorption member.

The present disclosure can implement a CO₂ capture device that contributes to improving waste heat utilization efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A illustrates a CO₂ capture cycle in a CO₂ capture device according to a first embodiment;

FIG. 1B illustrates the CO₂ capture cycle in the CO₂ capture device according to the first embodiment;

FIG. 1C illustrates the CO₂ capture cycle in the CO₂ capture device according to the first embodiment;

FIG. 1D illustrates the CO₂ capture cycle in the CO₂ capture device according to the first embodiment;

FIG. 1E illustrates the CO₂ capture cycle in the CO₂ capture device according to the first embodiment;

FIG. 1F illustrates the CO₂ capture cycle in the CO₂ capture device according to the first embodiment;

FIG. 2 is a block diagram showing the configuration of a control system for the CO₂ capture device according to the first embodiment;

FIG. 3A illustrates a CO₂ capture cycle in a CO₂ capture device according to a second embodiment;

FIG. 3B illustrates the CO₂ capture cycle in the CO₂ capture device according to the second embodiment;

FIG. 3C illustrates the CO₂ capture cycle in the CO₂ capture device according to the second embodiment;

FIG. 3D illustrates the CO₂ capture cycle in the CO₂ capture device according to the second embodiment;

FIG. 3E illustrates the CO₂ capture cycle in the CO₂ capture device according to the second embodiment;

FIG. 3F illustrates the CO₂ capture cycle in the CO₂ capture device according to the second embodiment;

FIG. 3G illustrates the CO₂ capture cycle in the CO₂ capture device according to the second embodiment;

FIG. 3H illustrates the CO₂ capture cycle in the CO₂ capture device according to the second embodiment; and

FIG. 4 is a block diagram showing the configuration of a control system for the CO₂ capture device according to the second embodiment.

### DETAILED DESCRIPTION OF EMBODIMENTS

Hereinafter, specific embodiments to which the present disclosure is applied will be described in detail with reference to the drawings. However, the present disclosure is not limited to the following embodiments. The following description and the drawings are simplified as appropriate for clarity.

### First Embodiment

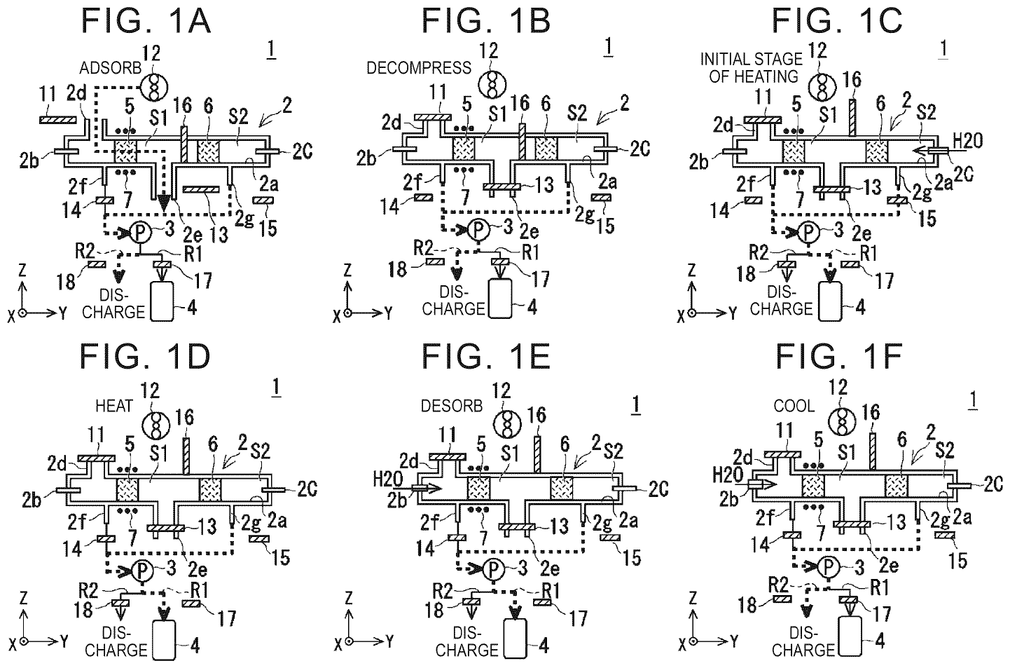

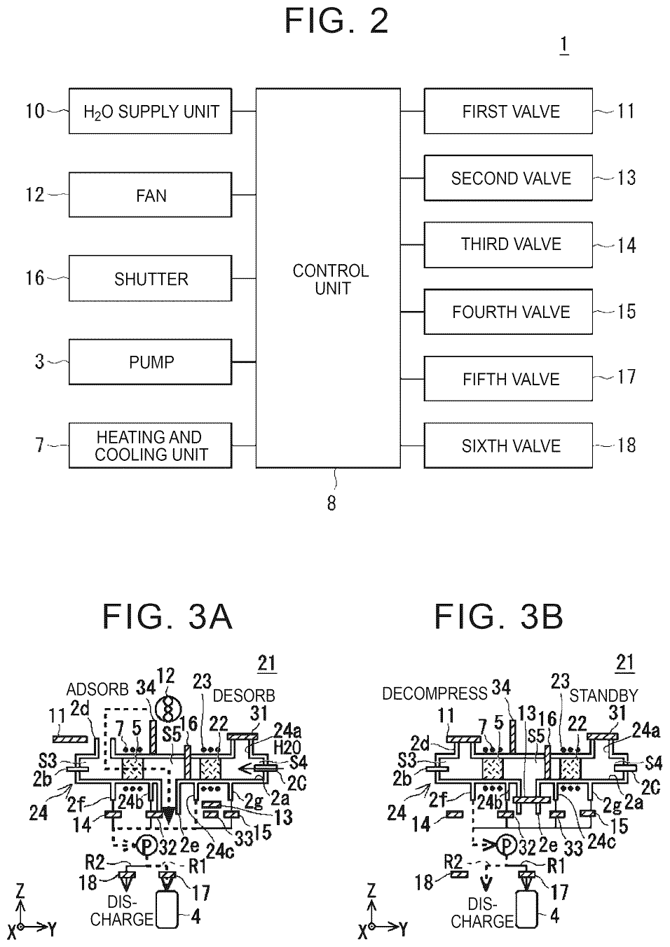

FIGS. 1A to 1F illustrate a CO₂ capture cycle in a CO₂ capture device according to a first embodiment. FIG. 2 is a block diagram showing the configuration of a control system for the CO₂ capture device according to the first embodiment. In the following description, a three-dimensional (XYZ) coordinate system will be used for clarity. In FIGS. 1A to 1F, the flows of gas and H₂O are shown by dashed lines.

As shown in FIGS. 1A to 1F, a CO₂ capture device 1 of the present embodiment is configured to capture CO₂ contained in gas using a CO₂ adsorption member that is a so-called solid adsorption member. As shown in FIGS. 1A to 1F and FIG. 2, the CO₂ capture device 1 includes a flow pipe 2, a pump 3, a tank 4, a CO₂ adsorption member 5, a heat absorption member 6, a heating and cooling unit 7, and a control unit 8.

As shown in FIGS. 1A to 1F, the flow pipe 2 includes a channel 2a for passing gas therethrough in order to capture CO₂ from the gas. For example, the flow pipe 2 extends in the Y-axis direction, and is closed at its end on the Y+ side and its end on the Y− side.

As shown in FIGS. 1A to 1F, a first insertion port 2b for inserting gas-phase H₂O that is a representative example of a fluid into the channel 2a of the flow pipe 2 is provided in the end on the Y-side of the flow pipe 2. A second insertion port 2C for inserting gas-phase H₂O into the channel 2a of the flow pipe 2 is provided in the end on the Y+ side of the flow pipe 2. The first insertion port 2b and the second insertion port 2C are connected to an H₂O supply unit 10 (see FIG. 2).

As shown in FIGS. 1A to 1F, a third insertion port 2d for inserting gas is provided in the end on the Z+ side of the flow pipe 2 that is a portion on the Y-side of the flow pipe 2. The third insertion port 2d can be opened and closed by a first valve 11. At this time, gas is preferably sent into the third insertion port 2d using, for example, a fan 12 etc. The gas may be either air taken in from the atmosphere or exhaust gas from a combustion mechanism.

As shown in FIGS. 1A to 1F, a first discharge port 2e for discharging gas is provided in the end on the Z− side of the flow pipe 2 that located substantially in the middle in the Y-axis direction of the flow pipe 2. The first discharge port 2e can be opened and closed by a second valve 13.

As shown in FIGS. 1A to 1F, a second discharge port 2f for discharging gas is provided in the end on the Z− side of the flow pipe 2 that is a portion on the Y-side of the flow pipe 2. The second discharge port 2f can be opened and closed by a third valve 14.

As shown in FIGS. 1A to 1F, a third discharge port 2g for discharging gas is provided in the end on the Z− side of the flow pipe 2 that is a portion on the Y+ side of the flow pipe 2. The third discharge port 2g can be opened and closed by a fourth valve 15.

A shutter 16 configured to open and close the channel 2a is provided in the flow pipe 2 so that the shutter 16 can divide the channel 2a into a first space S1 on the Y− side including the first discharge port 2e and a second space S2 on the Y+ side with respect to the first discharge port 2e.

The pump 3 sucks in gas from the channel 2a of the flow pipe 2. As shown in FIGS. 1A to 1F, the pump 3 is connected to the second discharge port 2f and the third discharge port 2g. The pump 3 is connected to a capture-side path R1 and a discharge-side path R2.

The capture-side path R1 is connected to the tank 4, and a fifth valve 17 is provided in the capture-side path R1. The tank 4 stores the gas pumped from the pump 3. A sixth valve 18 is provided in the discharge-side path R2.

The CO₂ adsorption member 5 captures gaseous CO₂ inserted into the flow pipe 2. The CO₂ adsorption member 5 can be a common solid adsorption member. An example of the CO₂ adsorption member 5 is a ceramic honeycomb material coated with an adsorbent that can adsorb CO₂ such as an amine. The ceramic honeycomb material is a material that is used in catalysts for motor vehicles etc.

In other words, the CO₂ adsorption member 5 has a honeycomb structure. As shown in FIGS. 1A to 1F, the CO₂ adsorption member 5 is disposed between the third insertion port 2d and second discharge port 2f and the first discharge port 2e so that gas can pass therethrough in the Y-axis direction in the first space S1 of the flow pipe 2.

The heat absorption member 6 absorbs heat of the CO₂ adsorption member 5, and is used as a heat source when heating the CO₂ adsorption member 5. The heat absorption member 6 can be made of, for example, a ceramic honeycomb material that is used in catalysts for motor vehicles etc. In other words, the heat absorption member 6 also has a honeycomb structure.

The heat absorption member 6 may have any configuration as long as it can exchange heat and allows a fluid to pass therethrough in the Y-axis direction. As shown in FIGS. 1A to 1F, the heat absorption member 6 is disposed between the shutter 16 and the third discharge port 2g so that gas can pass therethrough in the Y-axis direction in the second space S2 of the flow pipe 2.

The heating and cooling unit 7 heats and cools the CO₂ adsorption member 5. For example, as shown in FIGS. 1A to 1F, the heating and cooling unit 7 is configured to heat or cool the CO₂ adsorption member 5 via the flow pipe 2 by circulating a heat source through a tube wound so as to cover the outer periphery of the region where the CO₂ adsorption member 5 is disposed in the flow pipe 2.

As shown in FIG. 2, the control unit 8 controls the H₂O supply unit 10, the first valve 11, the fan 12, the second valve 13, the third valve 14, the fourth valve 15, the shutter 16, the fifth valve 17, the sixth valve 18, the pump 3, and the heating and cooling unit 7. The control unit 8 desirably executes a program to implement a process of capturing gaseous CO₂ using the CO₂ capture device 1 described below.

Next, how to capture gaseous CO₂ using the CO₂ capture device 1 of the present embodiment will be described. In the following description, the valves 11, 13, 14, 15, 17, and 18 and the shutter 16 are assumed to be closed unless otherwise specified. Also, the H₂O supply unit 10, the fan 12, and the pump 3 are assumed to be stopped unless otherwise specified.

First, with the CO₂ adsorption member 5 cooled and the heat absorption member 6 heated, the control unit 8 controls the first valve 11 and the second valve 13 to open the third insertion port 2d and the first discharge port 2e, as shown in FIG. 1A. The control unit 8 then controls the fan 12 to insert gas into the first space S1 of the flow pipe 2. As a result, the CO₂ adsorption member 5 adsorbs CO₂ contained in the gas.

At this time, as shown in FIG. 1A, the control unit 8 desirably controls the fourth valve 15 and the sixth valve 18 to open the third discharge port 2g and the discharge-side path R2, and controls the pump 3 to suck in the gas in the second space S2 of the flow pipe 2. A very small amount of gas that has entered the second space S2 through the shutter 16 can thus be discharged.

Next, as shown in FIG. 1B, the control unit 8 controls the third valve 14 and the sixth valve 18 to open the second discharge port 2f and the discharge-side path R2, and controls the pump 3 to suck in the gas in the first space S1 of the flow pipe 2. The first space S1 of the flow pipe 2 can thus be decompressed. At this time, the control unit 8 desirably controls the fourth valve 15 to open the third discharge port 2g to discharge a very small amount of gas that has entered the second space S2 of the flow pipe 2.

Thereafter, as shown in FIG. 1C, the control unit 8 controls the shutter 16 to allow the first and second spaces S1, S2 of the flow pipe 2 to communicate with each other, and controls the fifth valve 17 to open the capture-side path R1. At this time, the pump 3 keeps sucking in the gas, and the third valve 14 is kept open. The control unit 8 then controls the H₂O supply unit 10 to insert gas-phase H₂O from the second insertion port 2C.

At this time, the first and second spaces S1, S2 of the flow pipe 2 are desirably in a reduced pressure environment in which H₂O does not condense in the first space S1 and the second space S2, and that can increase the desorption rate of CO₂ from the CO₂ adsorption member 5 and can reduce oxidation of the CO₂ adsorption member 5 when the CO₂ adsorption member 5 is heated.

As a result, gas-phase H₂O passes through the CO₂ adsorption member 5 via the heated heat absorption member 6 and is collected in the tank 4. At that time, the CO₂ adsorption member 5 can be heated by the heat stored in the heat absorption member 6.

Next, as shown in FIG. 1D, the control unit 8 controls the fourth valve 15 to open the third discharge port 2g. At this time, the pump 3 keeps sucking in the gas, and the fifth valve 17 and the shutter 16 are kept open.

With the first and second spaces S1, S2 of the flow pipe 2 being in the reduced pressure environment, the control unit 8 controls the heating and cooling unit 7 to heat the CO₂ adsorption member 5 via the flow pipe 2. CO₂ that is gradually desorbed from the CO₂ adsorption member 5 can thus be captured in the tank 4.

Thereafter, as shown in FIG. 1E, with the first and second spaces S1, S2 of the flow pipe 2 being in the reduced pressure environment, the control unit 8 controls the H₂O supply unit 10 to insert gas-phase H₂O from the first insertion port 2b into the first and second spaces S1, S2 of the flow pipe 2, thereby forcing CO₂ out of the CO₂ adsorption member 5 by the H₂O, and passing the H₂O through the heat absorption member 6 via the heated CO₂ adsorption member 5. At this time, the pump 3 keeps sucking the gas, the fourth valve 15, the fifth valve 17, and the shutter 16 are kept open, and the heating and cooling unit 7 keeps heating the CO₂ adsorption member 5.

In this manner, CO₂ can be satisfactorily captured from the CO₂ adsorption member 5, and the heat absorption member 6 can be heated by the heat stored in the CO₂ adsorption member 5. H₂O may be separated from CO₂ in the capture-side path R1, or may be collected in the tank 4 together with CO₂.

As shown in FIG. 1F, when the capture of CO₂ from the CO₂ adsorption member 5 is finished, the control unit 8 controls the sixth valve 18 to open the discharge-side path R2 and controls the heating and cooling unit 7 to cool the CO₂ adsorption member 5 via the flow pipe 2, with the first and second spaces S1, S2 of the flow pipe 2 being in the reduced pressure environment. At this time, the pump 3 keep sucking in the gas, the fourth valve 15 and the shutter 16 are kept open, and the H₂O supply unit 10 keeps inserting the gaseous H₂O.

The CO₂ adsorption member 5 is thus cooled and regenerated so that it can adsorb CO₂. The steps of FIGS. 1A to 1F are then repeated. The CO₂ capture device 1 of the present embodiment can thus capture CO₂ from gas.

As described above, the CO₂ capture device 1 of the present embodiment is configured to directly transfer the heat of the heated CO₂ adsorption member 5 from the CO₂ adsorption member 5 to the heat absorption member 6 by gas-phase H₂O to heat the heat absorption member 6. The CO₂ capture device 1 of the present embodiment is also configured to heat the CO₂ adsorption member 5 by directly transferring the heat of the heated heat absorption member 6 from the heat absorption member 6 to the CO₂ adsorption member 5 by gas-phase H₂O. Therefore, the CO₂ capture device 1 of the present embodiment can contribute to improving waste heat utilization efficiency compared to the CO₂ capture device of JP 5914300 B.

In the CO₂ capture device 1 of the present embodiment, the third discharge port 2g that is used when capturing CO₂ is located downstream of the CO₂ adsorption member 5 in the flow of H₂O. Therefore, CO₂ forced out of the CO₂ adsorption member 5 by H₂O can be satisfactorily captured.

In the CO₂ capture device 1 of the present embodiment, the CO₂ adsorption member 5 has a honeycomb structure. Therefore, the CO₂ adsorption member 5 has a large contact area with gas, so that its CO₂ adsorption efficiency can be improved.

The CO₂ capture device 1 of the present embodiment uses gas-phase H₂O as a fluid for heating and cooling the CO₂ adsorption member 5 and for forcing CO₂ out of the CO₂ adsorption member 5. This can reduce oxidation of the CO₂ adsorption member 5 that has adsorbed CO₂ and wetting of the CO₂ adsorption member 5.

### Second Embodiment

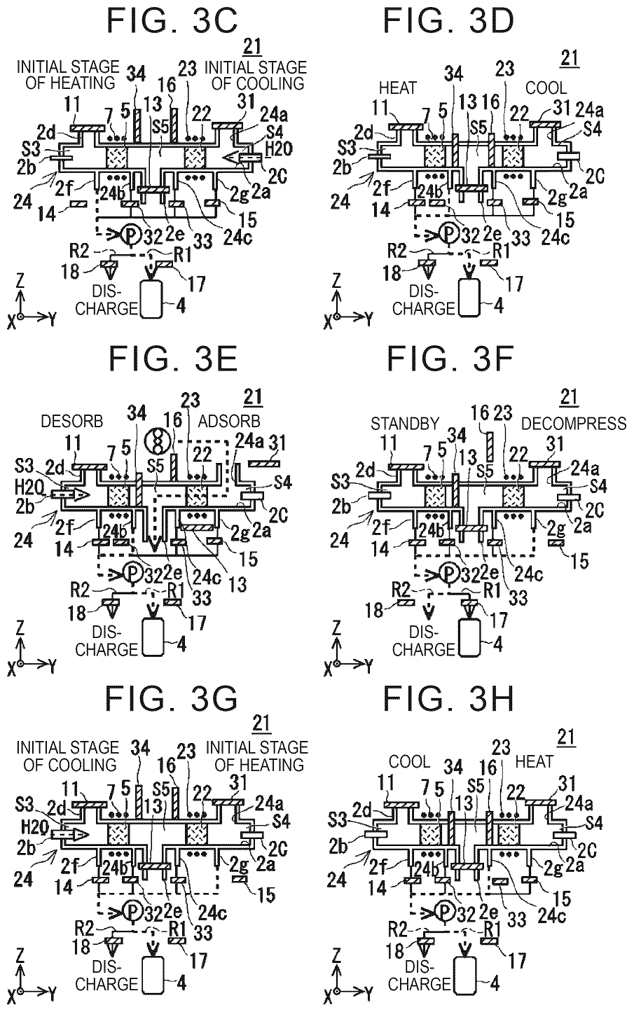

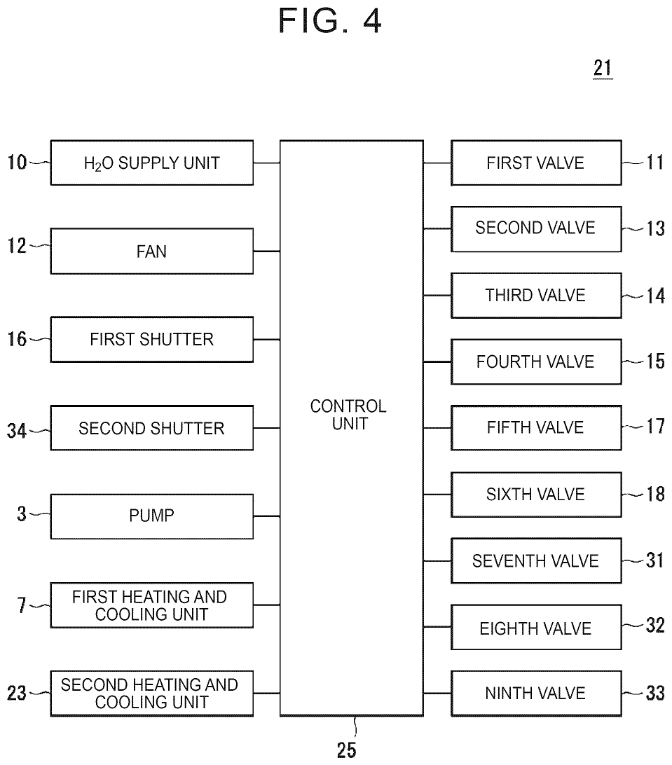

FIGS. 3A to 3H illustrate a CO₂ capture cycle in a CO₂ capture device according to a second embodiment. FIG. 4 is a block diagram showing the configuration of a control system for the CO₂ capture device according to the second embodiment. In the following description, the same members as those in the first embodiment are denoted by the same signs. In FIGS. 3A to 3H, the flows of gas and H₂O are shown by dashed lines, and the fan 12 is not shown in some of the figures.

As shown in FIGS. 3A to 3H, a CO₂ capture device 21 of the present embodiment is configured to capture CO₂ alternately from the CO₂ adsorption member (first CO₂ adsorption member) 5 and a second CO₂ adsorption member 22 by using the second CO₂ adsorption member 22 as the heat absorption member 6 according to the basic principle of the waste heat utilization of the CO₂ capture device 1 of the first embodiment.

The second CO₂ adsorption member 22 may have substantially the same configuration as the first CO₂ adsorption member 5. As shown in FIGS. 3A to 3H, the second CO₂ adsorption member 22 can be heated and cooled by a second heating and cooling unit 23 via a flow pipe 24.

As shown in FIGS. 3A to 3H, a fourth insertion port 24a is provided in the end on the Z+ side of the flow pipe 24 that is a portion on the Y+ side of the flow pipe 24. The fourth insertion port 24a can be opened and closed by a seventh valve 31.

As shown in FIGS. 3A to 3H, a fourth discharge port 24b is provided in the end on the Z− side of the flow pipe 24 between the first CO₂ adsorption member 5 and the first discharge port 2e in the flow pipe 24. The fourth discharge port 24b can be opened and closed by an eighth valve 32.

As shown in FIGS. 3A to 3H, a fifth discharge port 24c is provided in the end on the Z− side of the flow pipe 24 between the second CO₂ adsorption member 22 and the shutter (first shutter) 16 in the flow pipe 24. The fifth discharge port 24c can be opened and closed by a ninth valve 33.

As shown in FIGS. 3A to 3H, a second shutter 34 configured to open and close the channel 2a is provided between the first discharge port 2e and the fourth discharge port 24b in the flow pipe 24. That is, the first shutter 16 is disposed on the Y+ side with respect to the first discharge port 2e in the Y-axis direction, and the second shutter 34 is disposed on the Y-side with respect to the first discharge port 2e in the Y-axis direction.

As shown in FIGS. 3A to 3H, the channel 2a of the flow pipe 24 can thus be divided into a first space S3 located on the Y-side with respect to the first discharge port 2e, a second space S4 located on the Y+ side with respect to the first discharge port 2e, and a third space S5 around the first discharge port 2e.

As shown in FIG. 4, a control unit 25 controls the second heating and cooling unit 23, the seventh valve 31, the eighth valve 32, the ninth valve 33, and the second shutter 34 in addition to the H₂O supply unit 10, the first valve 11, the fan 12, the second valve 13, the third valve 14, the fourth valve 15, the first shutter 16, the fifth valve 17, the sixth valve 18, the pump 3, and the heating and cooling unit (first heating and cooling unit) 7.

Next, how to capture gaseous CO₂ using the CO₂ capture device 21 of the present embodiment will be described. In the following description, the valves 11, 13, 14, 15, 17, 18, 31, 32, and 33, the first shutter 16, and the second shutter 34 are assumed to be closed unless otherwise specified. Also, the H₂O supply unit 10, the fan 12, and the pump 3 are assumed to be stopped unless otherwise specified.

First, as shown in FIG. 3A, with the first CO₂ adsorption member 5 cooled and the second CO₂ adsorption member 22 heated after adsorbing CO₂ and with the second space S4 of the flow pipe 24 being in a reduced pressure environment. the control unit 25 controls the second shutter 34 to allow the first and third spaces S3, S5 of the flow pipe 24 to communicate with each other.

The reduced pressure environment is desirably a reduced pressure environment in which H₂O does not condense in the channel 2a of the flow pipe 24, and that can increase the desorption rate of CO₂ from the first CO₂ adsorption member 5 or the second CO₂ adsorption member 22 and can reduce oxidation of the first CO₂ adsorption member 5 or the second CO₂ adsorption member 22.

As shown in FIG. 3A, the control unit 25 then controls the first valve 11 and the second valve 13 to open the third insertion port 2d and the first discharge port 2e. The control unit 25 also controls the fan 12 to insert gas into the first and third spaces S3, S5 of the flow pipe 24. As a result, the first CO₂ adsorption member 5 adsorbs CO₂ contained in the gas.

As shown in FIG. 3A, the control unit 25 also controls the second heating and cooling unit 23 to heat the second CO₂ adsorption member 22 via the flow pipe 24, and controls the ninth valve 33 and the fifth valve 17 to open the fifth discharge port 24c and the capture-side path R1.

As shown in FIG. 3A, the control unit 25 controls the pump 3 to maintain the reduced pressure environment in the second space S4 of the flow pipe 24, and controls the H₂O supply unit 10 to insert gas-phase H₂O from the second insertion port 2C into the second space S4 of the flow pipe 24. CO₂ forced out of the second CO₂ adsorption member 22 by the gas-phase H₂O is thus captured in the tank 4.

Next, as shown in FIG. 3B, the control unit 25 controls the third valve 14 and the sixth valve 18 to open the second discharge port 2f and the discharge-side path R2. At this time, the pump 3 keeps sucking in the gas, and the second shutter 34 is kept open. As a result, the first and third spaces S3, S5 of the flow pipe 24 are in a reduced pressure environment. At this time, the second CO₂ adsorption member 22 side is in a standby state.

Thereafter, as shown in FIG. 3C, the control unit 25 controls the first shutter 16 to allow the first, third, and second spaces S3, S5, and S4 of the flow pipe 24 to communicate with each other, and controls the fifth valve 17 to open the capture-side path R1. At this time, the pump 3 keeps sucking in the gas, and the second shutter 34 and the third valve 14 are kept open.

As shown in FIG. 3C, with the first, second, and third spaces S3, S4, and S5 of the flow pipe 24 being in the reduced pressure environment, the control unit 25 then controls the H₂O supply unit 10 to insert gas-phase H₂O from the second insertion port 2C into the first, second, and third spaces S3, S4, and S5 of the flow pipe 24, and passes the gas-phase H₂O through the first CO₂ adsorption member 5 via the second CO₂ adsorption member 22 storing heat. In this manner, the second CO₂ adsorption member 22 can be cooled, and the first CO₂ adsorption member 5 can be heated by the heat stored in the second CO₂ adsorption member 22.

As shown in FIG. 3D, the control unit 25 then controls the eighth valve 32 to open the fourth discharge port 24b. At this time, the pump 3 keeps sucking in the gas, and the fifth valve 17 is kept open. With the first space S3 of the flow pipe 24 being in the reduced pressure environment, the control unit 25 controls the first heating and cooling unit 7 to heat the first CO₂ adsorption member 5 via the flow pipe 24. CO₂ that is gradually desorbed from the first CO₂ adsorption member 5 is thus captured in the tank 4.

As shown in FIG. 3D, the control unit 25 also controls the second heating and cooling unit 23 to cool the second CO₂ adsorption member 22 via the flow pipe 24. The second CO₂ adsorption member 22 is thus cooled and regenerated so that it can adsorb CO₂.

As shown in FIG. 3E, with the first space S3 of the flow pipe 24 being in the reduced pressure environment, the control unit 25 then controls the H₂O supply unit 10 to insert gas-phase H₂O from the first insertion port 2b into the first space S3 of the flow pipe 24. At this time, the pump 3 keeps sucking in the gas, the fifth valve 17 and the eighth valve 32 are kept open, and the first heating and cooling unit 7 keeps heating the CO₂ adsorption member 5. CO₂ forced out of the first CO₂ adsorption member 5 by the gas-phase H₂O is thus captured in the tank 4.

As shown in FIG. 3E, the control unit 25 also controls the second valve 13 and the seventh valve 31 to open the first discharge port 2e and the fourth insertion port 24a, and controls the first shutter 16 to allow the second and third spaces S4, S5 of the flow pipe 24 to communicate with each other.

As shown in FIG. 3E, the control unit 25 also controls the fan 12 to insert gas into the second and third spaces S4, S5 of the flow pipe 24. As a result, the second CO₂ adsorption member 22 adsorbs CO₂ contained in the gas.

Thereafter, as shown in FIG. 3F, the control unit 25 controls the fourth valve 15 and the sixth valve 18 to open the third discharge port 2g and the discharge-side path R2. At this time, the pump 3 keeps sucking in the gas, and the first shutter 16 is kept open. As a result, the second and third spaces S4, S5 of the flow pipe 24 are in a reduced pressure environment. At this time, the first CO₂ adsorption member 5 side is in a standby state.

As shown in FIG. 3G, the control unit 25 then controls the second shutter 34 to allow the first, third, and second spaces S3, S5, and S4 of the flow pipe 24 to communicate with each other, and controls the fifth valve 17 to open the capture-side path R1. At this time, the pump 3 keeps sucking in the gas, and the first shutter 16 and the fourth valve 15 are kept open.

As shown in FIG. 3G, with the first, second, and third spaces S3, S4, and S5 of the flow pipe 24 being in the reduced pressure environment, the control unit 25 then controls the H₂O supply unit 10 to insert gas-phase H₂O from the first insertion port 2b into the first, second, and third spaces S3, S4, and S5 of the flow pipe 24, and passes the gas-phase H₂O through the second CO₂ adsorption member 22 via the first CO₂ adsorption member 5 storing heat. In this manner, the first CO₂ adsorption member 5 can be cooled, and the second CO₂ adsorption member 22 can be heated by the heat stored in the first CO₂ adsorption member 5.

As shown in FIG. 3H, the control unit 25 then controls the ninth valve 33 to open the fifth discharge port 24c. At this time, the pump 3 keeps sucking in the gas, and the fifth valve 17 is kept open. With the second space S4 of the flow pipe 24 being in the reduced pressure environment, the control unit 25 controls the second heating and cooling unit 23 to heat the second CO₂ adsorption member 22 via the flow pipe 24. CO₂ that is gradually desorbed from the second CO₂ adsorption member 22 is thus captured in the tank 4.

As shown in FIG. 3H, the control unit 25 also controls the first heating and cooling unit 7 to cool the first CO₂ adsorption member 5 via the flow pipe 24. The first CO₂ adsorption member 5 is thus cooled and regenerated so that it can adsorb CO₂.

The steps of FIGS. 3A to 3H are then repeated. The CO₂ capture device 21 of the present embodiment can thus capture CO₂ from gas alternatively by the first CO₂ adsorption member 5 and the second CO₂ adsorption member 22.

As described above, the CO₂ capture device 21 of the present embodiment is configured to heat the second CO₂ adsorption member 22 by directly transferring the heat of the heated first CO₂ adsorption member 5 from the first CO₂ adsorption member 5 to the second CO₂ adsorption member 22 by gas-phase H₂O. The CO₂ capture device 21 of the present embodiment is also configured to heat the first CO₂ adsorption member 5 by directly transferring the heat of the heated second CO₂ adsorption member 22 from the second CO₂ adsorption member 22 to the first CO₂ adsorption member 5 by gas-phase H₂O. Therefore, the CO₂ capture device 21 of the present embodiment can also contribute to improving waste heat utilization efficiency compared to the CO₂ capture device of JP 5914300 B.

Moreover, since gaseous CO₂ can be captured alternately by the first CO₂ adsorption member 5 and the second CO₂ adsorption member 22, the gaseous CO₂ can be efficiently captured.

The present disclosure is not limited to the above embodiments, and can be modified as appropriate without departing from the spirit and scope of the present disclosure. In the above embodiments, gas-phase H₂O is inserted into the flow pipes 2, 24. However, any fluid can be inserted as long as it can transfer heat.

What is claimed is:

1. A CO₂ capture device that captures CO₂ from gas, the CO₂ capture device comprising:
a channel through which the gas is passed to capture CO₂;
a first CO₂ adsorption member disposed in the channel;
a heat absorption member disposed next to the first CO₂ adsorption member in the channel;
a first insertion port that is provided in the channel and through which a fluid is inserted into the channel in such a manner that the fluid flows through the heat absorption member via the first CO₂ adsorption member; and
a second insertion port that is provided in the channel and through which the fluid is inserted into the channel in such a manner that the fluid flows through the first CO₂ adsorption member via the heat absorption member, wherein the fluid is passed through the heat absorption member via the first CO₂ adsorption member heated to desorb CO₂ to heat the heat absorption member, and when heating the first CO₂ adsorption member, the fluid is passed through the first CO₂ adsorption member via the heat absorption member to heat the first CO₂ adsorption member.

2. The CO₂ capture device according to claim 1, wherein, when desorbing CO₂ from the first CO₂ adsorption member, the fluid is passed through the heat absorption member via the first CO₂ adsorption member, and CO₂ is discharged from a discharge port provided on a heat absorption member side with respect to the first CO₂ adsorption member in the channel.

3. The CO₂ capture device according to claim 1, wherein the heat absorption member is a second CO₂ adsorption member,
when heating the second CO₂ adsorption member, the fluid is passed through the second CO₂ adsorption member via the first CO₂ adsorption member to heat the second CO₂ adsorption member, and
when heating the first CO₂ adsorption member, the fluid is passed through the first CO₂ adsorption member via the second CO₂ adsorption member to heat the first CO₂ adsorption member.

4. The CO₂ capture device according to claim 1, wherein the first CO₂ adsorption member and the heat absorption member have a honeycomb structure.

5. The CO₂ capture device according to claim 1, wherein the fluid is H₂O that is in a gas phase when the channel is in a reduced pressure environment.
